(19) United States
(12) Patent Application Publication
(10) Pub. No.: US 2009/0107020 A1
(43) Pub. Date: Apr. 30, 2009

(54) PORTABLE DISPLAY FRAME

(76) Inventor: Gary Aires, San Diego, CA (US)

Correspondence Address: JACKSON, DEMARCO, TIDUS & PACKENPAUGH, 2815 TOWNSGATE ROAD, SUITE 200, WESTLAKE VILLAGE, CA, 91361-3010, US

(21) Appl. No.: 12/165,917

(22) Filed: Jul. 1, 2008

Related U.S. Application Data
(63) Continuation-in-part of application No. 11/978,894, filed on Oct. 29, 2007, now abandoned.

(51) Int. Cl. G09F 15/00; G09F 7/00

(52) U.S. Cl. 40/610

(57) ABSTRACT

Disclosed is a portable display frame formed of a base secured to a support. The inflatable support incorporates inflatable tubes.

### CROSS-REFERENCES TO RELATED APPLICATIONS

This application is a continuation-in-part application of U.S. patent application Ser. No. 11/978,894 filed Oct. 29, 2007.

### STATEMENT REGARDING FEDERALLY-SPONSORED RESEARCH OR DEVELOPMENT

Not applicable.

### BACKGROUND OF THE INVENTION

1. Field of the Invention

This invention relates to the mechanical arts. More particularly, it relates to portable display frames.

2. Discussion of the Related Art

Inflatable display frames are known in the art. See, for example, U.S. Pat. No. 7,181,877 B2. However, known display frames present a number of difficulties including difficulties associated with assembly, placing into service, changing the advertising message, and securing including preventing movement and overturning.

Solutions for such difficulties are some of the more pertinent objects of the portable display frame of the present disclosure. These objects should be construed to be merely illustrative of some of the more prominent features and applications of the portable display frame of the present disclosure. Other beneficial results can be attained by applying the disclosed portable display frame of the present disclosure in a different manner or by modifying the portable display frame of the present disclosure within the scope of the disclosure.

Accordingly, other objects and a fuller understanding of the portable display frame of the present disclosure may be had by referring to the summary of the portable display frame of the present disclosure and the detailed description of the preferred embodiment in addition to the scope of the portable display frame of the present disclosure defined by the claims taken in conjunction with the accompanying drawings.

### SUMMARY OF THE INVENTION

The display frame of the present disclosure overcomes the problems associated with regulations, is extremely portable, light in weight, easy to assemble, place into service, easily adapted to display different advertising message, and placeable and securable virtually anywhere and to anything, even the hood, trunk or roof of a vehicle. It is sturdy and affords an excellent view of the message content of the sign or banner placed thereon. Signs may be easily placed or removed and can be placed on the front of the display frame, on the back of the display frame, and on either or both sides of the display frame.

Briefly stated, the portable display frame of the present disclosure contemplates a pliable base sheet or an inflatable base secured to an inflatable support, the inflatable support formed of a plurality of panels and the panels formed of inflatable tubes. In some embodiments, a cover bearing the advertising message is stretched over the display frame and in some embodiments the advertising message is displayed on an LED display such as a flexible LED display attached to such a cover.

In some embodiments, the portable display frame has a non-inflatable, pliable base sheet secured to an inflatable support made of an A-frame configuration having two inverted-V panels formed of substantially vertically-disposed inflatable side tubes on each side connected together at the top by an horizontally-disposed inflatable top tube. In other embodiments the base includes inflatable tubes.

In some embodiments filling one of the inflatable tubes of the display frame causes all of the inflatable tubes of the display frame to be inflated where all of the inflatable tubes of the display frame are in fluid communication. And, in some embodiments, a plurality of inflatable tubes may be inflated from a plurality of inflation points such as one inflation point for each inflatable tube.

In other embodiments, the inflatable support is made of a pyramidal configuration having a plurality of triangular panels formed of inflatable tubes connected together at their vertices, such that the inner chambers of each of the panels are in communication with one another. An air valve or a self-inflating device, such as a gas generator, compressed gas cylinder or fan/compressor on any one of the inflatable tubes delivers air to inflate the portable display frame and produce its display shape. In some of these embodiments a low profile self inflating device is used to enable shipment of the display frame in low profile packaging enabling assembly at, for example, a point of use merely by placing the package in the desired location, freeing the inflatable support to expand during inflation and enabling the self-inflator.

In various embodiments, the display frame may be secured to an external surface by way of a magnetized border around its base perimeter where the external surface exhibits ferromagnetic properties, by weights placed on the border, by weights attached to the frame and in particular to the base of the frame, or by grommets in the border around the base perimeter through which stakes may be driven or a rope or line threaded and tied thereto and to an external object. In some embodiments the display can be secured using a bungee cord, D-clips, straps or other suitable means. And in some embodiments, the base sheet is formed of a bladder or supports a bladder, which can be filled with any suitable ballast, such as water or sand.

The foregoing has outlined pertinent and important features of the portable display frame of the present disclosure in order that the detailed description that follows may be better understood so the present contributions to the art may be more fully appreciated. Additional features of the portable display frame of the present disclosure will be described hereinafter which form the subject of the claims. As will be appreciated by those skilled in the art, the conception and the disclosed specific embodiment may be readily utilized as a basis for modifying or designing other structures and methods for carrying out the same purposes of the portable display frame of the present disclosure. It also should be realized by those skilled in the art that such equivalent constructions and methods do not depart from the spirit and scope of the portable display frame of the present disclosure as set forth in the appended claims.

### BRIEF DESCRIPTION OF THE DRAWINGS

For a fuller understanding of the nature and objects of the portable display frame of the present disclosure, reference should be had to the following detailed description taken in conjunction with the accompanying drawings in which:

FIG. 1 is perspective view of a display frame of a first preferred embodiment.

FIG. 2 is a top plan view of a display frame of a second preferred embodiment.

FIG. 3 is a bottom plan view of a display frame in accordance with the invention.

FIG. 4 is a bottom plan view of an alternative embodiment of a display frame in accordance with the invention.

FIG. 5 is perspective view of a display frame of a third preferred embodiment.

FIG. 6A is a perspective view of a display frame of a second preferred embodiment.

FIG. 6B is a perspective view of a cover for the display frames of FIGS. 1 and 6A.

FIG. 7 is a top view of a deflated support of the display frame of FIG. 6A.

FIG. 8 is a top view of a deflated base of the display frame of FIG. 6A.

FIG. 9 is a cross-sectional view of a portion of an inflatable tube of the display frames of FIGS. 1 and 6A.

### DETAILED DESCRIPTION OF THE PREFERRED EMBODIMENTS

The portable display frame of this disclosure, being inflatable and deflatable, renders it extremely light in weight and portable. Its shape and structure provides for excellent viewing, from all sides, of displayed content and also for excellent placement, on and from, virtually anywhere. Displayed content includes content displayed directly on the display frame, on banners supported by the frame and on covers supported by the frame. The use of banners and/or covers simplifies the task of changing the advertising message displayed.

Referring now to the drawings in detail, reference character 10 generally designates a portable display frame constructed in accordance with preferred embodiments thereof. It is formed of a base 13 on which is seated a support 11. In various embodiments, one or both of the base and the support include one or more inflatable chambers.

In an embodiment, a non-inflatable base sheet and an inflatable support are included. Here, the base sheet 13 is relatively flat and pliable such that it can adapt to the shape of an irregular external surface upon which it may be set; such as, but not limited to, a vehicle's roof, trunk, or hood; a truck bed; or on the ground, e.g., on sand, grass, rocks, concrete, asphalt and the like.

The base sheet 13 can be made out of any suitable pliable material. Preferred materials include polyvinylchloride (PVC), nylon, polyester and tarpaulin (cloth, such as canvas or polyester, coated with a plastic, such as latex or PVC), with PVC being most preferred. The thickness of the base sheet will be from about 0.125 inch to about 0.725 inch and, in some embodiments, from about 0.25 inch to about 0.5 inch.

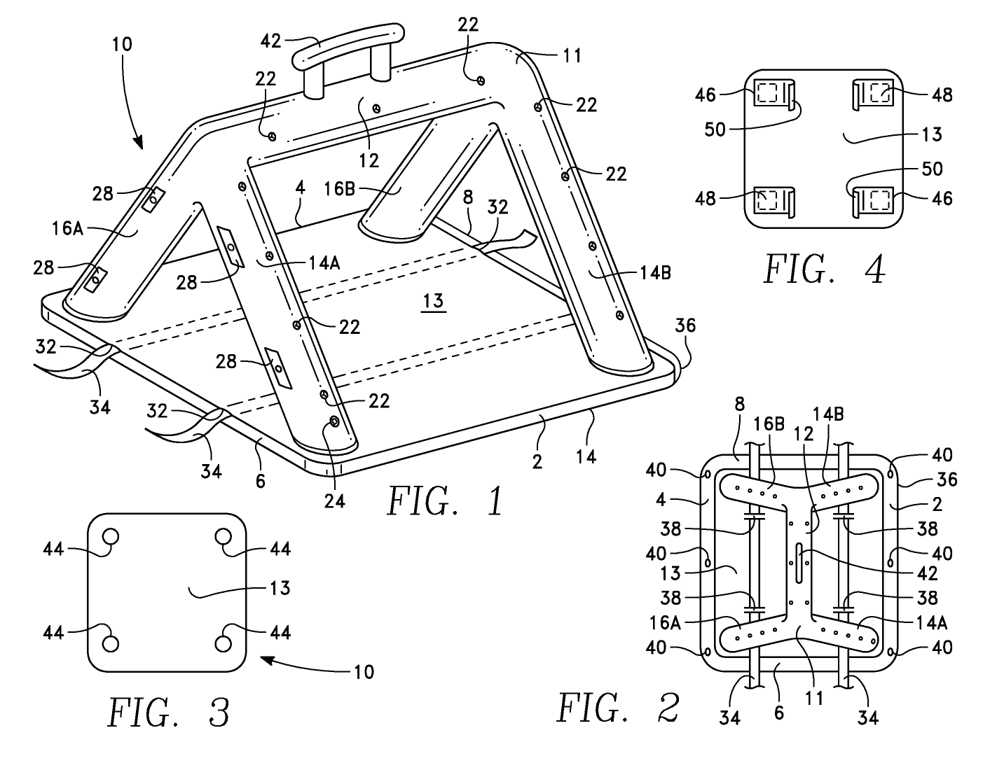

In some embodiments, the base sheet 13 is a laminate made from two or more layers. The layers can be formed from the same or different pliable materials. And in the embodiments shown if FIGS. 1 and 2, with respect to the sign or banner to be displayed, the base sheet 13 has a front 2 and a rear 4, with a first or left side 6 and a second or right side 8. The dimensions of the base sheet will be readily determinable by one skilled in the art without undue experimentation upon reading the instant specification. The dimensions will depend primarily upon the size of the sign or banner to be displayed and on the surface to which the display frame is to be secured. For example, when the display frame is secured to an outer surface of a vehicle such as a vehicular roof, trunk, or hood, lateral dimensions in the range of about 12 to 40 inches by about 12 to 40 inches or less are anticipated. When the display frame is secured to a truck bed the lateral dimensions will be in the range of about 40 to 72 inches by about 40 to 72 inches or less are anticipated.

The inflatable support 11 is formed from a plurality of tubes, each tube substantially enveloping an inflatable inner chamber. Such tubes are referred to herein as inflatable tubes and in various embodiments such as are suitable for particular applications, for example light duty and heavy duty applications, may be have a single-wall construction or a multi-wall construction including structures referred to as a tube within a tube. In the embodiments shown in FIGS. 1 and 2, on the left side 6 of the base sheet 13, a first inflatable front tube 14A extends upward from the base and angles rearward. Also on the left side of the base sheet, a first inflatable rear tube 16A extends upward from the base sheet and frontward. The first front tube 14A connects to the first rear tube 16A with and at the top tube 12 on the left side thereof.

On the right side 8 of the base sheet 13, a second inflatable front tube 14B extends upward from the base sheet and angles rearward. Also on the right side of the base sheet, a second inflatable rear tube 16B extends upward from the base sheet and frontward. The second front tube 14B connects to the second rear tube 16B with and at the top tube 12 on the right side thereof. The rearward and frontward-angling of the respective tubes 14A, 14B, 16A, 16B bear angles, measured from the base, of from approximately 40° to approximately 80°.

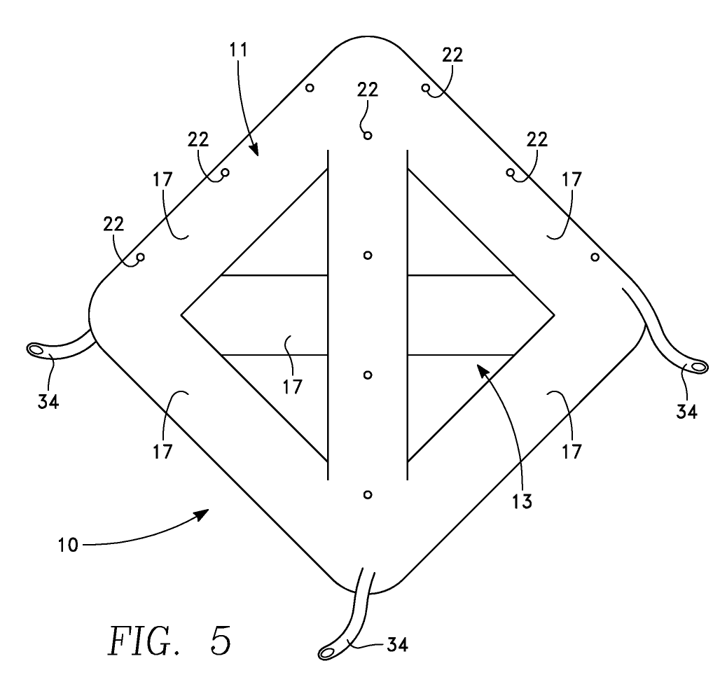

In the embodiment shown in FIG. 5, the inflatable support 11 has a pyramidal configuration. The pyramidal is formed of a plurality of triangular panels made of inflatable side tubes 17 connected together at their vertices, such that the inner chambers of each panel is are communication with one another.

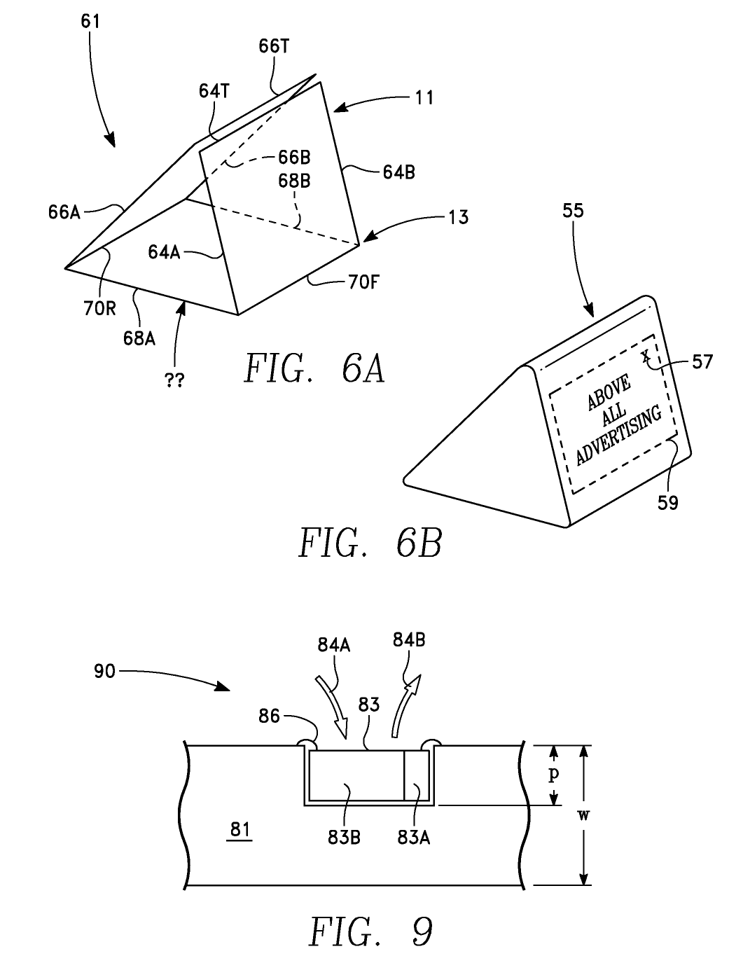

FIG. 6A shows an embodiment of the portable display frame having an inflatable base and a support 61. In some embodiments, the base is weighted and/or attached to a structure for stability. In various embodiments, one or more inflatable tubes are included in the base and in some embodiments, one or more inflatable tubes are included in the support. In a preferred embodiment, the support includes one or more inflatable tubes. In some embodiments, deformation of parts of the base including inflated portions provides for adaptation of the base of the portable display structure to irregular surfaces supporting the portable display frame.

In an embodiment of the portable display frame having an inflatable base and an inflatable support, the inflatable base is formed of inflatable tubes 68A, 68B, 70F, 70R, each inflatable tube defining an inner chamber and the inflatable tubes interconnected end-to-end to form a rectangular base. On the left side 6 of the base 13 a first inflatable front tube 64A extends upward from the base and angles rearward and on the right side of the base 8 a second inflatable front tube 64B extends upward from the base sheet and angles rearward. Extending between and attached to each of the upper ends of the first and second front tubes is a first inflatable top tube 64T.

On the left side of the base 6 a first inflatable rear tube 66A extends upward from the base and angles forward and on the right side of the base 8 a second inflatable rear tube 66B extends upward from the base and angles forward. Extending between and attached to each of the upper ends of the first and second rear tubes is a second inflatable top tube 66T. The rearward and frontward-angling of the respective tubes 64A, 64B, 66A, 66B bear angles, measured from the base, of from approximately 40° to approximately 80°.

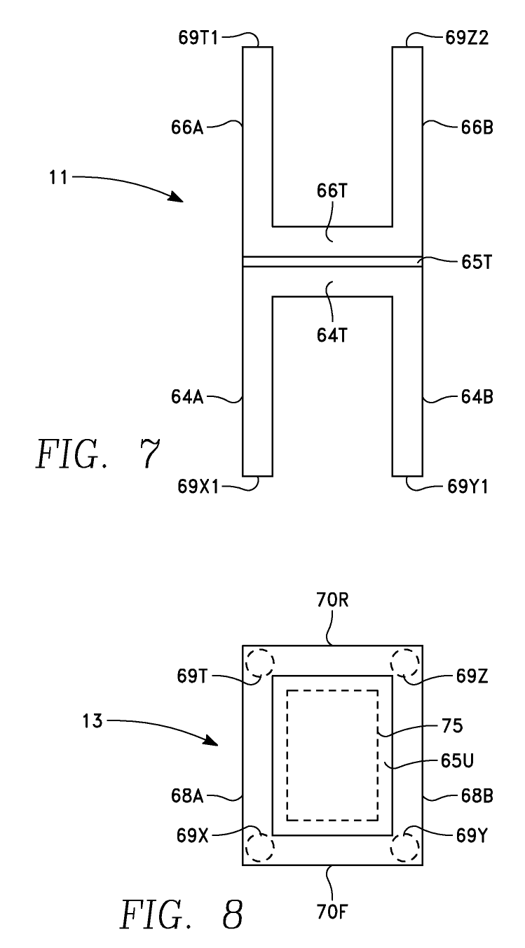

FIG. 7 shows an embodiment of the support 11 of the portable display frame of FIG. 6. The support of FIG. 7 is deflated and laid flat to illustrate construction details. In this embodiment, tubes 64A, 64T, 64B are joined to form an “n” shape defining front feet 69X1, 69Y1 and inflatable tubes 66A, 66T, 66B are joined to form a “u” shape defining rear feet 69Z1, 69T1. In some embodiments, a non-inflatable interface panel 65T joins the “n” shaped lower part of the support and the “u” shaped upper part of the support. As will be appreciated by a person of ordinary skill in the art, in some embodiments the top tubes 64T, 66T abut when the display frame is assembled and inflated; and, in some of these embodiments portions of one top tube 64T are secured to portions of the other top tube 66T by, for example, joining the edges or other adjacent portions of the top tubes using suitable adhesives or similar means known in the art.

FIG. 8 shows an embodiment of the base 13 of the portable display frame of FIG. 6. The base of FIG. 8 is deflated and laid flat to illustrate construction details. In this embodiment, four inflatable tubes 68A, 70F, 68B 70R are joined end-to-end to form a four-sided base. Four interface areas on an upper side of the base 69X, 69Y, 69Z, 69T are secured, at least in part, to respective feet 69X1, 69Y1, 69Z1, 69T1 of the support.

In an embodiment, the base of FIG. 8 includes an inflatable bladder 75 supported by the tubes of the base 68A, 70F, 68B, 60R. For example, filling such bladder and/or other tubes of the base with a liquid such as water or granular material such as sand provides a ballast tending to stabilize the portable display frame. In some embodiments, a non-inflatable interface panel 65U extends between some or all of a perimeter of the ballast and adjacent portions of the base tubes. And, in some embodiments, a web, diaphragm or other suitable holding means of the base receives one or more removable ballasts. For example, a diaphragm filling the interior of the base and joined at its perimeter with an internal perimeter of the base tubes provides a suitable means for holding a ballast or weight for stabilizing the portable display frame.

In an embodiment, a plurality of inflatable tubes are filled from a plurality of inlets or inlet valves. In various embodiments two or more of the internal chambers of the tubes may be fluidly connected to enable fluid communication between such tubes to facilitate inflation of the support and/or the base. In a preferred embodiment, all of the inner chambers of the inflatable tubes of the base and support are in fluid communication such that inflation of one inflatable tube of the portable display frame results in all of the inflatable tubes of the portable display frame being inflated.

The tubes can be made from different, preferably identical, inflatable material. Suitable inflatable tube materials include PVC, nylon, and polyester, with PVC being most preferred.

The tubes can have different or, preferably, identical, cross sectional shapes, with circular cross sections being preferred. The outer diameters of the tubes will be readily determinable by one skilled in the art without undue experimentation upon reading the instant specification. The outer diameters will depend primarily upon the size of the sign or banner to be displayed and must provide sufficient rigidity, so that the frame is self supporting when inflated. The outer diameters will typically be in the range of from about six inches to about twenty-four inches and, in some embodiments, from about eight inches to about eighteen inches. The thickness of the tubes is typically from about 0.125 inch to about 0.725 inch and, in some embodiments, from about 0.25 inch to about 0.5 inch.

The length of each tube is determined primarily by the size of the base and flag or banner to be supported. Displays for the roof of the hood of a motor vehicle are typically on the order of thirty-six inches in height, while displays for the bed of a truck are typically on the order of seventy-two inches in height.

Each tube envelops an inner chamber and, in a an embodiment, each inner chamber is in communication with each other inner chamber. The inner chambers permit air or gas passage through the entire support 11. When gas is introduced into the support, each tube will fill up, gas therein will be contained, and the structure will attain and retain its shape.

As shown in FIGS. 1 and 6, one or more of the base 13 and the support 11 is inflated and deflated using an air valve 24, on tubes which are so equipped. As shown in FIG. 9, an alternate embodiment 90 including a self-inflating device, is used.

Suitable self-inflating devices 83 for inflating a tube(s) 81 include a gas supply 83A and a gas supply control means 83B. Such devices include a gas generator incorporating two or more suitable chemicals, a compressed gas cylinder, or an electrically powered air mover such as a fan or a pump having an electric motor as its prime mover and an electrical connection and/or electrical energy storage element. Where a reversible flow device such as a fan is used, tube inflation 84A and tube deflation 84B is accomplished by appropriate operation of said device. In some embodiments, the self-inflating device has a low profile “p” as compared to the tube width “w” or another dimension such as a standard packaging dimension.

In a low-profile for shipment embodiment of the display frame 10, a shipping package has a thickness in the range of about 1.5 to 2.5 inches. Here, a base 11 is secured to an inflatable support 13 having an inflatable tube incorporating a low-profile self-inflating device 83. Installation and setup of such a device includes placement in the desired location and opening partially or completely packaging blocking inflation of the support followed by operation of the self inflating device.

The inflatable support 11 can be attached to the noninflatable base sheet 13 by any suitable method, such as by sewing. In a preferred embodiment, where the front and rear tubes, 14A and 14B and 16A and 16B are made of PVC and the base sheet is made of PVC, the support can be attached by a suitable method know in the art such as heat welding.

A plurality of display attachment members 22 on each of the tubes are on the front, on the rear, and on each side thereof thereby permitting a sign or banner (not shown) to be placed on the front, on the rear, and on either side of the display frame 10 for viewing. Such attachment members 22 may be grommets, D-rings, clips, hook-and-loop components, and the like. The sign or banner, having cooperating structure, is attached to the attachment members 22 and held in place.

In the embodiments shown in FIGS. 1 and 2, the inflatable tubes also may have attachment members 28 for attaching flags, small banners, or streamers (not shown). Such attachment members 28 may include pockets, grommets, D-rings, clips, hook-and-loop components, and the like. The flag, small banner, or streamer, having cooperating structure, is attached to the attachment members 28 and held in place.

In some embodiments, advertising messages and/or other subject matter to be communicated to onlookers is displayed on a cover, such as fabric cover, that envelopes part or all of the support 11 and/or the base 13 of the display frame 10, 61. Such a cover 55 for advertising the business of “ABOVE ALL ADVERTISING” is shown in FIG. 6B. The subject matter to be communicated 57 may be painted, screen-printed, stitched, embossed, overlaid, glued, pinned or otherwise attached to and/or associated with the cover by another suitable means.

In other embodiments, the subject matter to be communicated appears on an electronic display such as a plasma or LED screen 59. Some such embodiments utilize a flexible LED display and, of these, preferred ones utilize a flexible LED display attached to the cover.

As a person of ordinary skill in the art will understand, a number of the features of FIG. 1 described below, including certain of the means of stabilizing the display frame of FIG. 1, are also applicable to the display frame of FIG. 6.

In the embodiment shown in FIG. 1, the base sheet 13 also has a sleeve 32 transversing the base sheet in a plurality of locations, while in the embodiment shown in FIG. 2, the base sheet has a plurality of loops 38 that are axially aligned on the surface of the base sheet in at least two locations. Straps 34 through the sleeves or loops extend well beyond the perimeter of the base sheet. The straps may be tied to an external surface, for securing the display frame 10 and preventing its displacement. Such embodiments find especial use where the display frame 10 is secured to the roof of a vehicle. Then, the straps 34 are placed, from opposite sides, through open windows of the vehicle. The straps 34 are brought toward each other and tied together or the straps 34 are tied to a secure object within the vehicle. In either event, the display frame is securely attached by the straps and capable of resisting, for example, severe wind conditions.

In alternative embodiments, the base sheet 13 includes a border 36 around its perimeter. In some embodiments, the border is magnetized. In a preferred embodiment, the border is weighted by having weights placed inside. The weights may be of any dense materials, such as but not limited to metal objects, and, or magnets. Using a weighted border 36 permits secure placement on any ground surface. And in some embodiments, the base sheet is formed of a bladder or supports a bladder, which can be filled with any suitable ballast, such as water or sand.

In various embodiments, the display frame may be secured to an external surface by way of a magnetized border around its base perimeter where the external surface exhibits ferromagnetic properties, by weights placed on the border, by weights attached to the frame and in particular to the base of the frame, or by grommets in the border around the base perimeter through which stakes may be driven or a rope or line threaded and tied thereto and to an external object. In some embodiments the display can be secured using a bungee cord, D-clips, straps or other suitable means.

Depending on the amount of weight, the display frame 10 will be secured from displacement due to wind conditions or jostling by passersby.

For more severe wind conditions, grommets 40 on the border 36 are adapted to accept stakes therethrough and into the ground surface to prevent displacement. A stake or rope or similar line may be threaded through the grommets and then tied to a more secure external structure or cleat, if on the ground, or tied to a vehicle or truck bed on the vehicle or in the truck bed. In still other embodiments, the display can be secured using weights, a bungee cord, D-clips, or other suitable means.

Turning to FIG. 3, there is shown an alternative embodiment for securing the display frame 10 to a relatively smooth surface, such as the hood or roof of a motor vehicle. A plurality of suction cups 44 fastened to the bottom of the base sheet 13 are used to secure the display frame to a suitable surface.

Then turning to FIG. 4, there is shown another alternative embodiment for securing the display frame 10 to a surface made of steel or other metal to which magnets stick. A plurality of pockets 46 are fastened to the bottom of the base sheet 13. A magnet 48 is placed in each pocket and the pocket can then be sealed using, for example, a Velcro flap 50.

As seen in FIGS. 1 and 2, some embodiments include a handle 42 attached to the top tube 12. The handle makes it easy to carry the display frame when the display frame is inflated.

The present disclosure includes that contained in the present claims as well as that of the foregoing description and drawings. Although this portable display frame of the present disclosure has been described in its preferred forms with a certain degree of particularity, it is understood that the present disclosure of the preferred forms has been made only by way of example and numerous changes in the details of construction and combination and arrangement of parts may be resorted to without departing from the spirit and scope of the portable display frame of the present disclosure. Accordingly, the scope of the portable display frame of the present disclosure should be determined not by the embodiment illustrated, but by the appended claims and their legal equivalents.

Applicant has attempted to disclose all the embodiments of the portable display frame of the present disclosure that could be reasonably foreseen. It must be understood, however, that there may be unforeseeable insubstantial modifications the to portable display frame of the present disclosure that remain as equivalents and thereby fall within the scope of the portable display frame of the present disclosure.

What is claimed is:

1. A display frame comprising:
a non-inflatable, pliable base sheet having a front, a rear, and a first side extending from the front to the rear, and a second side extending from the front to the rear; secured to
an inflatable support having
a rearward-angled inflatable first front tube on the front of the first side of said base;
a rearward-angled inflatable second front tube on the front of the second side of said base of said base and having an inner chamber;
a frontward-angled inflatable first rear tube on the rear of the first side of said base and having an inner chamber;
a frontward-angled inflatable second rear tube on the rear of the second side of said base and having an inner chamber; and,
at least one inflatable top tube having an inner chamber in fluid communication with inner chambers of the first front tube, the second front tube, the first rear tube and the second rear tube.

2. The display frame of claim 1 further comprising a cover enveloping substantially all of the support and the base.

3. The display frame of claim 2 wherein the cover bears a message to be communicated to onlookers.

4. The display frame of claim 2 wherein an electronic display supported by the display frame bears a message to be communicated to onlookers.

5. The display frame of claim 2 wherein a LED electronic display supported by the cover bears a message to be communicated to onlookers.

6. The display frame of claim 5 wherein the LED electronic display is a flexible LED electronic display.

7. The display frame of claim 3 further comprising:
a self-inflating device integral with one of said inflatable tubes;
the self-inflating device being a low-profile device;
low-profile packaging containing a deflated base and a deflated support; and,
means for placing a packaged display frame positioned in a desired location into service merely by operating the self-inflating device.

8. The display frame of claim 3 further comprising a single filler valve in fluid communication with all of the inflatable tubes of the frame.

9. The display frame of claim 3 further comprising a plurality of filler valves, each filler valve in fluid communication with at least a single inflatable tube of the frame.

10. A portable display frame comprising:
a base secured to a support;
the base having
a plurality of inflatable tubes connected end-to-end;
each inflatable base tube forming an inner chamber;
each of the inner chambers of the inflatable base tubes being in fluid communication;
the support having
a rearward-angled inflatable first front tube on the front of the first side of said base;
a rearward-angled inflatable second front tube on the front of the second side of said base of said base and forming an inner chamber;
a frontward-angled inflatable first rear tube on the rear of the first side of said base and forming an inner chamber;
a frontward-angled inflatable second rear tube on the rear of the second side of said base and forming an inner chamber;
at least one inflatable top tube having an inner chamber in fluid communication with inner chambers of the first front tube, the second front tube, the first rear tube and the second rear tube;
the at least one inflatable top tube being in fluid communication with at least one of the inflatable base tubes; and,
a cover bearing an advertising message said cover enveloping substantially all of the support and the base.

11. The display frame of claim 10 further comprising a cover enveloping substantially all of the support and the base.

12. The display frame of claim 11 wherein the cover bears a message to be communicated to onlookers.

13. The display frame of claim 11 wherein an electronic display supported by the display frame bears a message to be communicated to onlookers.

14. The display frame of claim 11 wherein a flexible LED electronic display supported by the cover bears a message to be communicated to onlookers.

15. The display frame of claim 12 further comprising a single filler valve in fluid communication with all of the inflatable tubes of the frame.

16. The display frame of claim 12 further comprising a plurality of filler valves, each filler valve in fluid communication with at least a single inflatable tube of the frame.

17. The display frame of claim 9 further comprising:
a self-inflating device integral with one of said inflatable tubes;
the self-inflating device being a low-profile device;
low-profile packaging containing a deflated base and a deflated support; and,
means for placing a packaged display frame positioned in a desired location into service merely by operating the self-inflating device.
